(19) United States
(12) Patent Application Publication
(10) Pub. No.: US 2012/0150438 A1
(43) Pub. Date: Jun. 14, 2012

(54) Road Information Provision System Using Navigation Device

(75) Inventor: Sung-il Hwang, Seoul (KR)

(73) Assignee: MAXFOR TECHNOLOGY INC., GYEONGGI-DO (KR)

(21) Appl. No.: 13/391,278

(22) PCT Filed: Aug. 19, 2009
(86) PCT No.: PCT/KR09/04622

§ 371 Date: Feb. 17, 2012

(51) Int. Cl. G01C 21/26

(52) U.S. Cl. 701/468

(57) ABSTRACT

The present invention relates to a system for providing road information using a navigation device, and provides road information detected by a road information provision device installed on the road to a driver by transmitting the road information to a navigation device in a wireless manner. Accordingly, the present invention has the advantage of a driver being able to promptly and precisely perceive road information, which has been detected by a road information provision device installed on the road and has been transmitted to a navigation device in a wireless manner, thus allowing the driver to safely drive the vehicle. Further, there is the advantage of road information being able to be provided directly from a road information provision device, so that there is no need to pass a separate facility for collecting, analyzing and providing road information or to subscribe to a separate service for road information.

### TECHNICAL FIELD

The present invention relates to a system for providing road information using a navigation device.

### BACKGROUND ART

Generally, Global Positioning System (GPS) localization devices have been mounted and used to detect the current locations and movement speeds of various moving objects such as ships, airplanes, or vehicles, or determine the path of movement thereof. Such a GPS localization device is configured to receive radio waves indicating latitude, longitude, altitude, etc. from a plurality of satellites, calculate the current location of each moving object, and display map information containing the current location of the moving object to a driver.

Further, such a navigation localization device has been usefully utilized to provide required information, such as the traveling direction of the moving object, distance to a destination, the current speed of the moving object, and road information, to the driver and in such a way as to help the driver prevent accidents by providing a warning to the driver for over-speed driving or notifying the driver of dangerous areas, accident black spots, etc.

In this way, it has become possible to provide various types of useful information and services to a vehicle and a driver via an information terminal mounted in a vehicle using localization technology for moving objects and a system enabling wireless communication, and so there has been an increased interest in this technology.

Meanwhile, in order for a driver to obtain traffic-related information, it is required to collect using an Advanced Traveler Information System (ATIS) in real time the amount of traffic and traffic flow conditions of principal roads, construction work or repair work, unexpected situations such as accidents, and surrounding situations, from a central traffic information center, to analyze such information, and to select an optimal route and adjust a driving schedule on the basis of an electronic map (navigator) mounted in the vehicle and media such as traffic broadcasting, roadside broadcasting, and an electric display panels for the road.

Utilizing such a system entails the burden of the electronic map mounted in a vehicle having to be continuously updated according to newly changed map information. Further, traffic broadcasting and roadside broadcasting results in the case where the driver must listen to even undesired information other than information about a required area. Furthermore, the above information generally requires a procedure for passing a facility, such as a central traffic information center which collects, analyzes and transmits traffic information, or a procedure for subscribing to and using a separate service for traffic information.

### DISCLOSURE

### Technical Problem

The present invention has been made keeping in mind the above problems, and an object of the present invention is to provide a road information provision system using a navigation device, which requires neither a separate facility for providing road information nor a subscription to a service for road information.

### Technical Solution

In accordance with an aspect of the present invention to accomplish the above object, there is provided a road information provision system using a navigation device, including a road information provision device installed on a road and configured to provide information about the road; and a navigation device configured to output information provided by the road information provision device, receive signals from a Global Positioning System (GPS) satellite and provide location information, wherein the road information provision device includes one or more detection units configured to detect the road information; and transmission units provided in the respective detection units so that pieces of road information detected by the respective detection units are transmitted in a wireless manner, and wherein the navigation device includes a reception unit for receiving the information transmitted in a wireless manner from the transmission units.

Further, the road information provided by the road information provision device may be information related to road conditions.

Furthermore, the road information provided by the road information provision device may be information related to traffic conditions of the road.

Furthermore, the road information provision device may be installed on a road surface of the road.

### Advantageous Effects

As described above, the present invention has the advantage of a driver being able to promptly and precisely perceive road information, which has been detected by a road information provision device installed on the road and has been transmitted to a navigation device in a wireless manner, thus allowing the driver to safely drive the vehicle.

Further, there is the advantage of road information being able to be provided directly from a road information provision device installed on the road, so that there is no need to pass a separate facility for collecting, analyzing and providing road information or to subscribe to a separate service for road information.

Furthermore, there is an advantage in that since information about only roads present around a vehicle is received and used, memory can be efficiently used.

### BRIEF DESCRIPTION OF DRAWINGS

FIG. 1 is a diagram showing a road information provision system using a navigation device according to an embodiment of the present invention;

FIG. 2 is a diagram showing the provision of road information to a navigation device according to an embodiment of the present invention; and

FIG. 3 is a diagram showing a form in which the road information provision system using a navigation device is used in an intersection according to an embodiment of the present invention.

### DESCRIPTION OF REFERENCE CHARACTERS OF IMPORTANT PARTS

100: road information provision system using navigation device
110: navigation device
111: input unit
112: display unit
113: sound processing unit
114: GPS reception unit
115: GPS data processing unit
116: map data storage unit
117: control unit
118: road information reception unit
120: road information provision device
122: road information detection unit
124: road information transmission unit
200: vehicle

### BEST MODE

Preferred embodiments of the present invention will be described in detail with reference to the attached drawings, and the technical part of well-known components may be omitted or summarized to simplify the description.

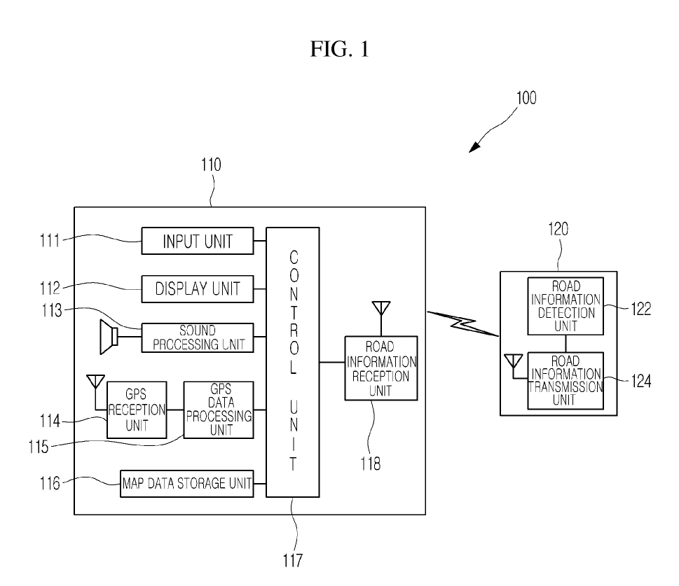

As shown in FIGS. 1 to 3, a road information provision system 100 using a navigation device according to an embodiment of the present invention includes a navigation device 110, a road information provision device 120, etc.

First, the navigation device 110 is also referred to as a car navigation system, and denotes a device equipped with a Global Positioning System (GPS) and configured to automatically display the location of a vehicle. The navigation device 110 includes an input unit 111, a display unit 112, a sound processing unit 113, a GPS reception unit 114, a GPS data processing unit 115, a map data storage unit 116, a control unit 117, and a road information reception unit 118.

The input unit 111 is implemented using a plurality of input buttons required to control the operation of the navigation device 110 or using a touch screen, and is configured to allow a driver to set up a desired route, so that a specific location is searched for in a facility database (DB) configured in the map data storage unit 116 using a name or an address and the route is set up, thus guiding the driver to the desired destination along the route.

The display unit 112 is configured to guide the driver through the route, set up by the driver via the input unit 111, using a screen at the same time that voice guidance is provided, thus effectively guiding the driver through the route. In particular, in the embodiment of the present invention, road information received from the road information reception unit 118 is provided to the driver.

The sound processing unit 113 is configured to output a voice or alarm sound together with information displayed on the screen of the display unit 112. That is, the sound processing unit 113 is configured such that effective route guidance is provided using voices required for route guidance, or such that a warning of road information is output as a voice, or such that a warning sound is generated and output.

The GPS reception unit 114 is used at the time of receiving GPS signals so as to determine the current location, and is configured to receive GPS signals from satellites and calculate the location using the received GPS signals, thus determining the current location. In this case, the GPS reception unit 114 receives location information and absolute time information from at least three GPS satellites.

The GPS data processing unit 115 processes the GPS signals received from the GPS reception unit 114 and calculates its location, and then transmits the calculated location to the control unit 117. That is, the GPS data processing unit 115 may determine the current location, predict the distance, movement time, etc. to the destination, and provide the predicted information to the driver via the display unit 112.

The map data storage unit 116 is composed of a road map, a background map, a facility DB, etc., and is configured on the premise of exact longitude and latitude coordinates, wherein the road map contains information about the shapes or the traffic regulations of roads and is configured to find a road or determine the road along which the vehicle is driving, thereby guiding the driver through the found or determined road on the display unit 112. Here, the background map refers to a shape drawn on the map, and the facility DB is mainly used for searching to enable a specific location to be found using the name or address thereof.

That is, the driver is provided with map data, including scaled map information and roads, oil stations and building names that are mapped according to the longitude and latitude of the map.

The control unit 117 controls the overall operation of the navigation device 110, and is configured to control the GPS signals processed by the GPS data processing unit 115, to combine the GPS signals with the map information provided in the map data storage unit 116, and to provide combined results to the driver via the display unit 112. In particular, the present invention is configured such that information about the conditions of the road surface of each road and the traffic conditions of the road that are transmitted from the road information reception unit 118 may be displayed on the display unit 112.

The road information reception unit 118 is configured to receive signals that have been detected by and transmitted from the road information provision device 120 mounted in the vehicle, and to transmit the signals to the control unit 117.

In this case, information transmitted to the road information reception unit 118 may correspond to various types of information related to road conditions such as the freezing, hydroplaning and temperature of the road, or traffic conditions. The road information provision device 120 includes a road information detection unit 122, a road information transmission unit 124, etc.

The road information detection unit 122 is installed on the road and is configured to perform the function thereof. In this case, the detected road information may correspond to road surface conditions such as the freezing, hydroplaning, and temperature of the road, or traffic conditions such as the traffic volume and traffic congestion.

In other words, when the road is frozen, the road information detection unit 122 transmits information about such freezing to the road information reception unit 118 of the navigation device 110, and then notifies the driver of such information via the display unit 112 and the sound processing unit 113 of the navigation device 110.

Further, when there is concern about the occurrence of hydroplaning between the tires of a driving vehicle and the road surface due to rainy weather, this information is transmitted to the road information reception unit 118 and is then provided to the driver, thus inducing the driver to safely drive the vehicle.

Meanwhile, it is also possible to detect the traffic volume and traffic congestion using the road information detection unit 122. Since this construction can immediately incorporate the conditions of vehicles passing along the road, the driver can be more promptly provided with more exact information.

In this regard, the road information detection unit 122 may be installed either on the road surface or on the roadside. When the road information detection unit 122 is installed on the road surface, it is possible to determine more exact road conditions on the route along which the vehicle is moving, and notify the driver of the road conditions. When the road information detection unit 122 is installed on the roadside, there is no direct friction and impact with the vehicle, and thus the lifespan of the device can be lengthened and the device can then be used.

The road information transmission unit 124 is configured to transmit the information detected by the road information detection unit 122 to the road information reception unit 118 provided in the navigation device 110, so that notification of the detected information can be provided to the driver using the navigation device 110.

That is, the information detected by the road information detection unit 122 is transmitted to the navigation device 100 via the road information transmission unit 124 using near-field communication. Here, since the transmitted information is information about roads around the vehicle 200 equipped with the navigation device 110, road information can be used without causing the waste of memory attributable to unnecessary information. Information about a road on which predetermined time has passed or from which the vehicle has deviated a predetermined distance, is automatically deleted, thus enabling the memory to be more efficiently used.

Meanwhile, near-field communication used between the road information reception unit 118 of the navigation device 110 and the road information transmission unit 124 of the road information provision device 120 is preferably implemented using Zigbee having a relatively small amount of data transmitted, low power consumption, and security, and may also be implemented using Bluetooth, infrared communication, etc.

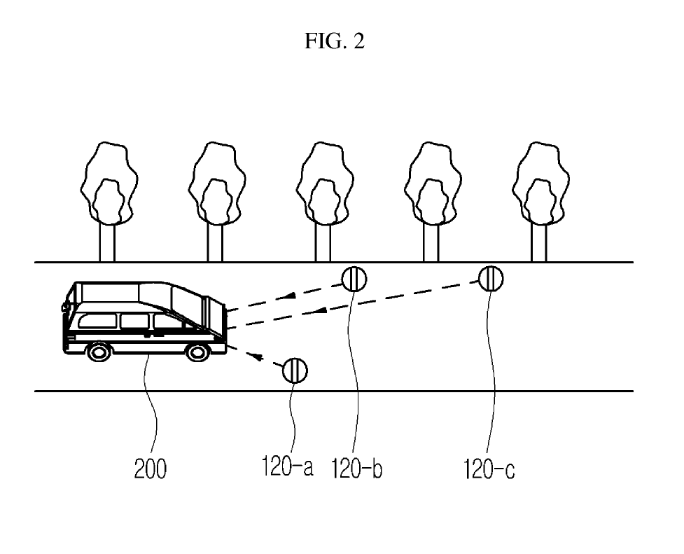

As described above, the road information provision system 100 using the navigation device according to the embodiment of the present invention is configured to transmit the road information detected by the road information provision device 120 installed on the road surface to the navigation device 110 mounted on the vehicle 200 passing along the relevant road, as shown in FIG. 2, so that the road information is provided to the driver.

In this case, on the road surface of the road, one or more road information provision devices 120-a, 120-b, and 120-c are installed, wherein individual road conditions are detected using the road information provision device 120-a for detecting the frozen state of the road, the road information provision device 120-b for detecting the speed of the vehicle 200 passing along the road, and the road information provision device 120-c for detecting the traffic congestion of the road and are transmitted to the navigation device 110, so that the road information useful to the driver is provided.

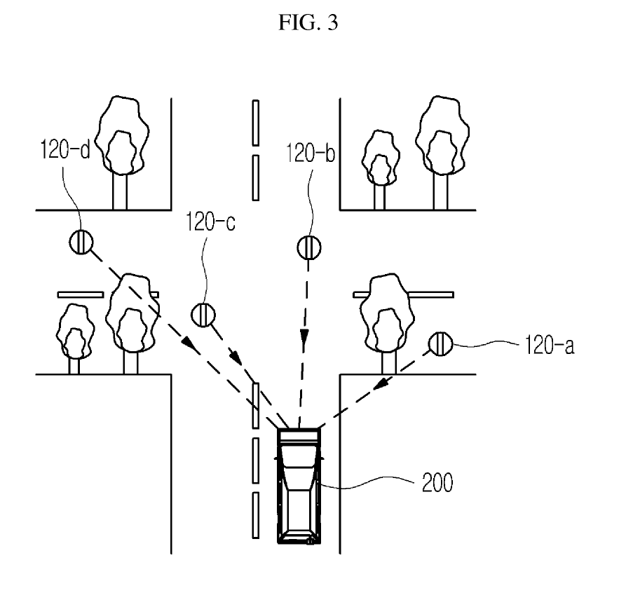

Meanwhile, when the embodiment of the present invention is used, it is possible to receive the road information of a blind spot that is not viewed when in an intersection, as shown in FIG. 3, so that the present invention helps the driver promptly perceive the presence of a dangerous factor or the road conditions, thus decreasing the risk of accidents and enabling driving to be safer.

That is, the present invention is configured such that, as shown in FIG. 3, the road information provision device 120-d installed at a location that cannot be viewed by the driver provides road information to the driver by transmitting the road information to the navigation device 110, thus helping the driver determine the current conditions or the like of a relevant road even in a blind spot.

Furthermore, when information about the traffic volume and traffic flow on the road is received, traffic conditions such as unexpected incidents occurring due to a sudden accident or construction are promptly provided in real time, so that a road from which information indicative of congested traffic is received may be bypassed, and another route may be selected and used.

As described above, although a detailed description of the above-described present invention has been given with reference to embodiments based on the attached drawings, the above embodiments are described as only preferred examples of the present invention, and thus it should not be understood that present invention is limited only to the embodiments, and it should be understood that the scope of the present invention is defined by the accompanying claims and equivalents thereof.

I claim:

1. A road information provision system using a navigation device, comprising:
a road information provision device installed on a road and configured to provide information about the road; and
a navigation device configured to output information provided by the road information provision device, receive signals from a Global Positioning System (GPS) satellite and provide location information,
wherein the road information provision device comprises:
one or more detection units configured to detect the road information; and
transmission units provided in the respective detection units so that pieces of road information detected by the respective detection units are transmitted in a wireless manner, and
wherein the navigation device comprises:
a reception unit for receiving the information transmitted in a wireless manner from the transmission units.

2. The road information provision system according to claim 1, wherein the road information provided by the road information provision device is information related to road conditions.

3. The road information provision system according to claim 1, wherein the road information provided by the road information provision device is information related to traffic conditions of the road.

4. The road information provision system according to claim 1, wherein the road information provision device is installed on a road surface of the road.
